(19) United States
(12) Patent Application Publication
(10) Pub. No.: US 2008/0038392 A1
(43) Pub. Date: Feb. 14, 2008

(54) Cord sheathing device with a mobile die

(75) Inventors: Michel Druet, Gerzat (FR); Nicolas Jaunet, Durtol (FR)

Correspondence Address: COHEN, PONTANI, LIEBERMAN & PAVANE, 551 FIFTH AVENUE, SUITE 1210, NEW YORK, NY, 10176, US

(73) Assignee: Michelin Recherche et Technique S.A., Granges-Paccot (CH)

(21) Appl. No.: 11/881,638

(22) Filed: Jul. 26, 2007

(30) Foreign Application Priority Data
Jul. 27, 2006 (FR) 06/06977

(51) Int. Cl. B29C 47/12; B05C 11/02; B05C 3/12

(52) U.S. Cl. 425/113; 118/125; 118/419

(57) ABSTRACT

A cord sheathing device for one or more cords (F) with a plastic or thermoplastic material, comprising guiding means (2) for the cord(s) arranged at the inlet of the device and leading to a central chamber (51) connected by a duct to extrusion means that can deliver the said material under pressure in the viscous condition, an outlet die (4) of given calibration section S₁ for the sheathed cord(s), and at least one mobile die (12) with calibration section S₂ smaller than the calibration section S₁. Each mobile die (12) is moved in the travel direction of the cord(s) F by an actuator (13, 15, 17), passing through the central chamber (51), and having a passage (14) allowing the central chamber (51) to communicate with the interior space of the mobile die (12).

### FIELD OF THE INVENTION

The invention concerns the field of covering a filiform element with a plastic or thermoplastic material, and in particular the sheathing of a cord with a mix of rubber or thermoplastic material.

### BACKGROUND OF THE INVENTION

‘Cord’ is understood to mean a filiform element composed of a single or several strands, whether textile or metallic, arranged together to form a single, unitary cord. The cord can also be described as a textile or metallic cable.

Cable sheathing devices as a general rule comprise means for guiding the cord once it has entered the device, a central chamber connected by a duct orientated perpendicularly to the travel direction of the cord to extrusion means capable of delivering under pressure a plastic or thermoplastic material in the viscous condition and in which the mixture under pressure coats the said cord, and an extrusion die of given calibrating section.

The material is deposited on the surface of the cord at the level of the central chamber. By its movement the cord draws the sheathing material towards the outlet die, whose calibrating section confers on the cord the shape of its final section.

A device of this type is described, as an example, in the publication WO 93/15896 for the fabrication of a coated unitary cord. Analogous devices are also known for coating with a viscous material plies of cords arranged side by side and parallel to one another in the same plane, so as to obtain a strip of coated cords.

A known problem related to the nature of such devices concerns control of the emerging section. In effect, it is observed that the quantity of rubber deposited, and consequently the diameter of the sheathed cord, decrease as the speed increases if a constant pressure level is maintained in the central chamber. This speed effect is related to the carrying along of the material by the cord.

The section of the sheath is therefore very slightly smaller than the section S of the calibrating die. It is thus necessary to increase the pressure in the central chamber in order to keep the section of the sheath constant wen the travel speed of the cord is increased.

This problem is described, for illustrative purposes, in the publication U.S. Pat. No. 5,169,548 which discloses a device for controlling the diameter by acting on the rotation speed of the extrusion screw or on the travel speed of the cord. Publication DE 24 57 249, discloses a device comprising two coaxial dies cap able of sheathing the cord alternatively with one or two coats of material. Publication JP 60 110 422 discloses a device capable of adjusting the pressure in the central chamber by modifying the axial position of the cords guiding means.

However, these control means are of limited effect when it is desired to obtain a sheath of small thickness and none of them address the problem of the sheathing speed increase.

In effect the pressure drop associated with the small calibrating section of the outlet die entails increasing the pressure in the central chamber to very high levels in order to reduce the speed-related effects described above.

It is then necessary to provide devices capable of regulating the pressure over large operating ranges, and this increases complexity and cost if it is desired to increase the amplitude of cord travel speed variations in the sheathing device.

### SUMMARY OF THE INVENTION

The purpose of the present invention is to provide an original solution for the problem.

According to the invention the device for sheathing one or more cords with a plastic or thermoplastic material comprises guiding means for the cord(s) arranged at the inlet of the device, leading to a central chamber connected by a duct to extrusion means capable of delivering the said material under pressure in the viscous condition, and an outlet die for the sheathed cord(s) of given calibration section S₁.

The device also comprises a mobile die with a calibration section S₂ smaller than the calibration section S₁. This die is moved in the travel direction of the cord by an actuator passing through the central chamber and having a passage alloxing the central chamber to communicate with the interior space of the mobile die. Thus, when the device is in operation, the actuator moves said mobile die between a position in which the said mobile die is interposed, downstream from the central chamber, between the central chamber and the outlet die, allowing the complete flow of material coming from the central chamber to flow through the mobile die after entering the passage of the actuator, and a second position in which the said mobile die is arranged upstream from the said central chamber, between the central chamber and the guiding means, allowing the complete flow of material coming from the central chamber to flow through the outlet die.

A further object of the invention is the process associated with the use of this device in which a mobile die, of calibration section S₂ smaller than the calibration section S₁ of the outlet die, is interposed between the central chamber and the outlet die when the cord(s) is/are moving at a low speed, whereas the mobile die is moved upstream from the central chamber when the cord(s) is/are moving at a high speed.

At low speed, the effect of the speed at which the cord carries along the material is small and the calibration section can then also be small, as obtained by interposing the mobile die downstream from the central chamber between the latter and the outlet die.

The material under pressure contained in the central chamber is brought in contact with the cord F and the sheath of material is formed, with the desired section, at the level of the calibration section of the mobile die.

As mentioned earlier, the section of the sheath formed around the cord is slightly smaller than the calibration section of the mobile die and consequently also smaller than the section of the outlet die. Thus, at low speed the outlet die does not affect the profile of the sheath formed at the level of the mobile die.

At high speed, the mobile die is moved upstream from the central chamber and then no longer plays any part in the formation of the sheath, whose characteristics are conferred by the outlet die whose calibration section is larger than the calibration section of the mobile die. The diameter decrease associated with the speed effect described above is greater and, to maintain a constant sheathing section, the pressure in the central chamber can be regulated while remaining within the same control range as that used for the speed. It is therefore no longer necessary to increase the pressure in the central chamber when the travel speed of the cord is increased.

Accordingly, this device enables a cord to be sheathed with a plastic or thermoplastic material in the viscous condition over a large range of speeds. Moreover, the system's performance is particularly good when it is desired to produce a sheath of small thickness.

### BRIEF DESCRIPTION OF THE DRAWINGS

A preferred embodiment of the invention is illustrated in FIGS. 1 to 7, in which:

FIG. 1 shows a schematic sectioned view of a sheathing device in which the mobile die is positioned between the outlet die and the central chamber, corresponding to the “low speed” configuration,

FIG. 2 shows a schematic sectioned view of the sheathing device with the mobile die positioned upstream from the central chamber, corresponding to the “high speed” configuration,

FIG. 3 shows a schematic perspective view of the cord guide positioned at the inlet of the sheathing device,

FIG. 4 shows a schematic perspective view of a mobile die extended by its actuator,

FIG. 5 shows a schematic perspective view of a scraper element,

FIG. 6 shows a schematic perspective view of the assembly of the mobile die fitted with its actuator, the scraper and the cord guide on their support,

FIG. 7 shows a schematic sectioned view of the mobile die fitted with its actuator, the scraper and the cord guide mounted on their support as illustrated in FIG. 6.

### DETAILED DESCRIPTION OF THE DRAWINGS

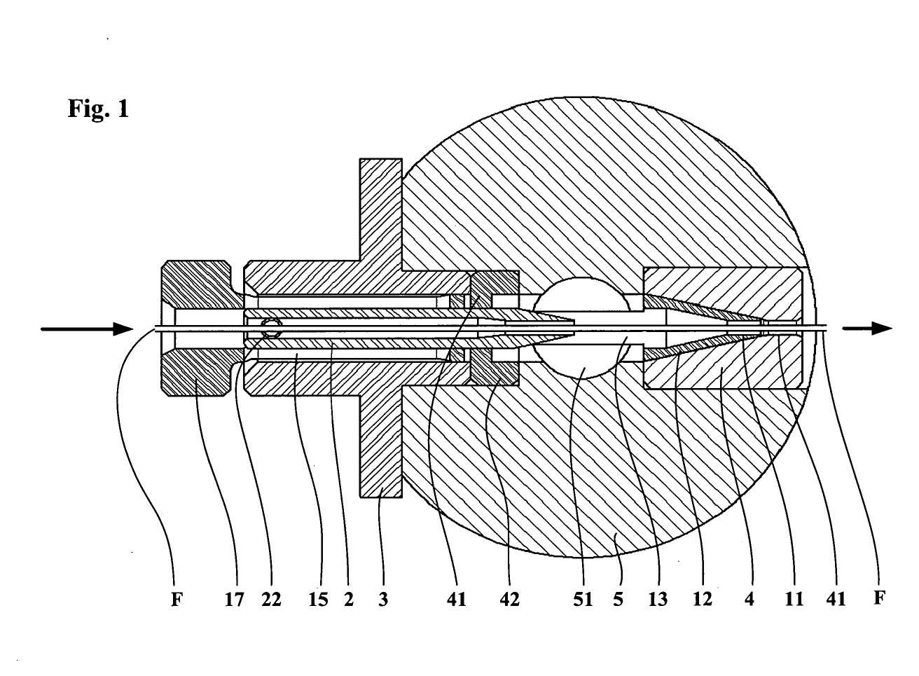

FIG. 1 shows a sheathing device according to the invention. The device comprises a body 5 surrounding the central chamber 51 connected by a duct to extrusion means (not shown). The function of the extrusion means is to feed the central chamber under pressure with plastic or thermoplastic material in the viscous condition. These means may be formed in an entirely classical way by an extruder comprising a screw arranged in a sleeve, whose rotation speed determines the flow rate and pressure. The screw can also be designed to act upon the plasticity and viscosity of the material so as to deliver to the central chamber a material with optimum characteristics for sheathing the cord.

It is also possible to use other extrusion means capable of delivering a material under pressure, such as volumetric pumps of the gear or piston type.

The device constituting the object of this description is more particularly designed to sheath a textile or metallic cord or cable with a rubber material. It should be noted, however, that provided the necessary adaptations are made to the characteristics of the materials used, the device and process according to the invention can just as well be used for sheathing a cord with any other type of material having viscosity properties that make it suitable for the sheathing operation. Thus, to sheath a cord with a thermoplastic material it will be necessary to take into account the specific thermal properties of the material so that it can be delivered to the central chamber under the desired viscosity conditions.

The body 5 is crossed from one side to the other by the cord F, which moves at a given speed in the direction of the arrows, passing in succession through the cord guide 2, the central chamber 51 and the outlet die 4.

The cord guide 2 is mounted on a support 3 itself attached firmly tot he body 5 by a number of screws (not shown). Its function is to centre the cord at the inlet of the central chamber and to prevent the rubber under pressure present in the said chamber from penetrating into the guiding device.

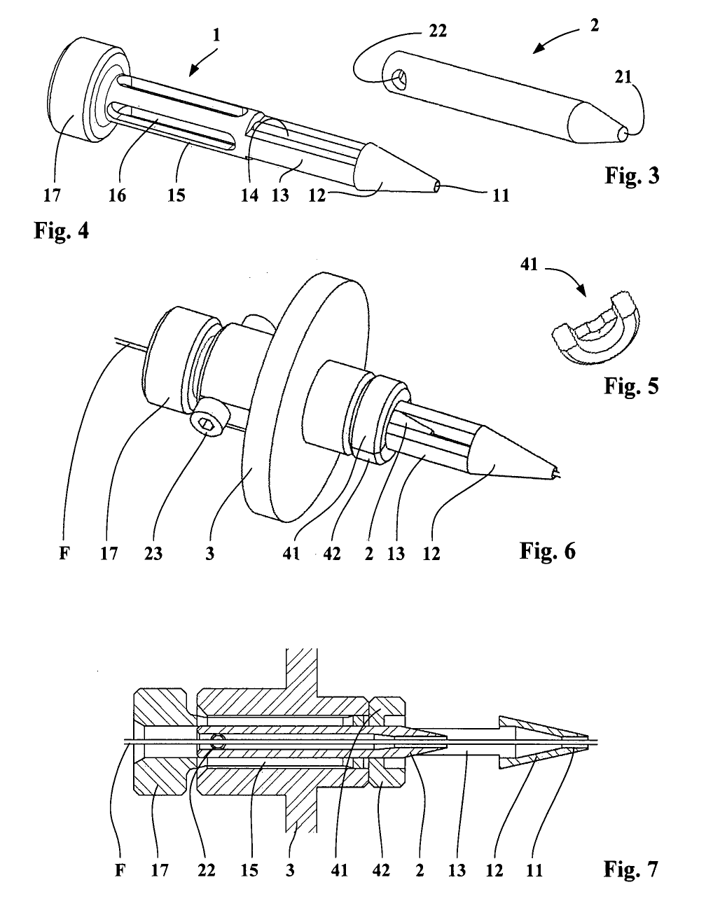

The cord guide is held on the support by two screws 23 inserted into threads 22 as shown in FIGS. 3 and 6. For the sake of information, the section of the outlet 21 of the cord guide is essentially equal to the section of the cord(s) increased by about 0.3/10^{th} of a millimetre. It will also be noted that the speed effect described earlier, combined with a small difference between the section of the cord and the outlet section of the cord guide, act favourably to prevent the rubber in the central chamber from coming out through the guiding device.

The mobile die 12 is shown in FIG. 1 in the “low speed” configuration, downstream from the central chamber 51 and upstream from the outlet die 4. In practice the shapes of the mobile die 12 and the outlet die 4 are adapted so that the two dies fit one inside the other so as to reduce the bulk of the assembly.

The outlet die 4 is fixed relative to the body 5.

The surface of the cord is coated at the level of the central chamber 51 and the shape of the final section of the sheath is given by the calibrating section S₂ located on the downstream portion 11 of the mobile die 12.

For illustrative purposes, when the section S is circular, i.e. when it is desired to obtain a sheathed unitary cord, the diameter difference between the section S₁ and the section S₂ is of the order of 1/10^{th} to 2/10^{th} of a millimetre. The speed range can vary from 0 to 8 m/s and the pressure range can easily be regulated between 1 Mpa and 20 Mpa when it is desired to deposit on the surface of the cord a rubber material that forms a layer 1/10^{th} of a millimetre thick.

The mobile die 12 is set in motion by an actuator connected to the rear portion of the mobile die 12. The actuator passes through the central chamber 51 and the support 3, and comprises a front portion 13, an intermediate portion 15 and a head 17 as illustrated in FIG. 4.

The front portion 13 of the actuator comprises a passage 14 which allows the material to circulate from the central chamber 51 to the interior volume of the mobile die through which the cord F passes when the device is operating and the mobile die is positioned in the “low speed” configuration.

The intermediate portion 15 of the actuator slides freely in the support 3 and around the cord guide 2. To allow this, longitudinal slots 16 are made all along this portion 15 so as to allow the passage of the screws 23 designed to keep the cord guide 2 in a fixed position attached to the support 3.

The rear portion of the actuator comprises a head 17, designed to be connected to an actuation mechanism (not shown) such as a pneumatic or hydraulic jack, or an electric actuator such as a linear motor.

According to this description the actuator is arranged upstream from the mobile die 12. It should be noted that the actuator can also be positioned downstream from the mobile die or even that a set of sliding elements could be designed, capable of moving the mobile die and arranged on the lateral part of the walls of the central chamber.

A scraper 4 formed of two half-shells 41 and 42 as illustrated in FIG. 5, is arranged on the front portion of the support. The shape of the scraper is designed to match the shape of the outer section of the front portion 13, 14 of the actuator. The purpose of the scraper is to prevent penetration of the material into the part of the support where the cord guide is arranged and in which the actuator moves when being displaced between its upstream and downstream positions from the central chamber.

Schematic views of the assembly comprising the support 3 containing the mobile die 12 and its actuator, the cord guide 2 and the scraper 41, 42 are shown in perspective in FIG. 6, and in section in FIG. 7.

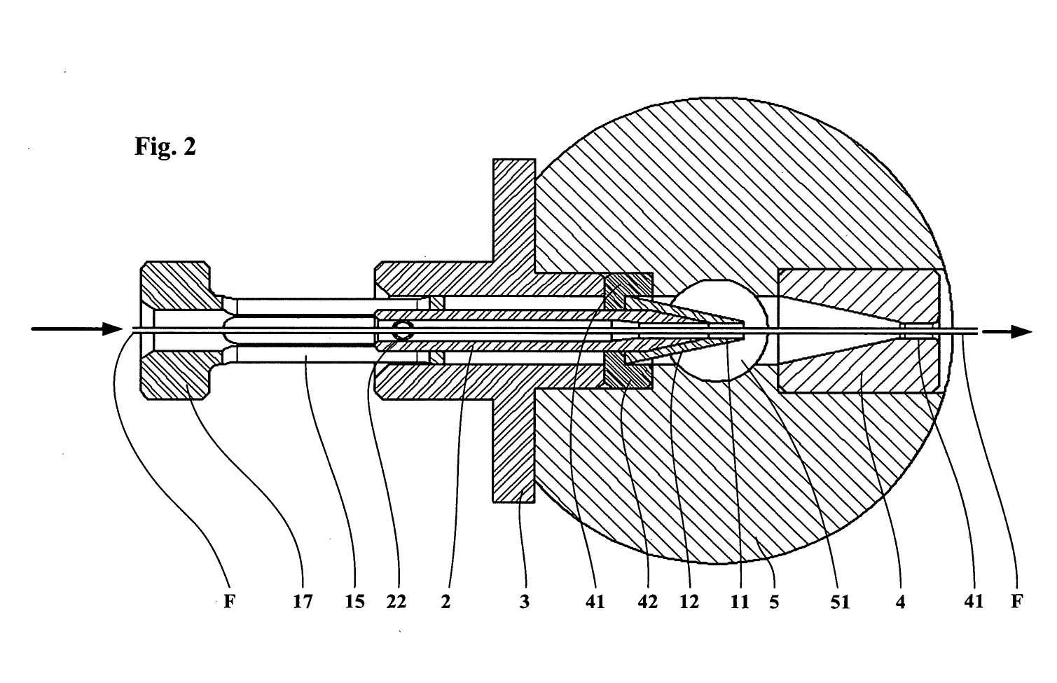

FIG. 2 shows the sheathing device in the so-termed “high speed” configuration. The mobile die 12 is moved upstream in the device and the internal portion of the mobile die fits around the end of the cord guide, clear of the interior space of the central chamber 51 which then communicates directly with the inside of the outlet die 4. The mobile die 12 is neutralised.

Calibration of the cord takes place at the level of the downstream portion 41 of the outlet die 4, whose section S₂ is larger than the section S₁ of the mobile die.

The device described here has a single mobile die 12 and one outlet die 4. It is also possible, without exceeding the scope of the invention, to arrange several mobile dies along the travel direction of the cord and upstream from the outlet die, whose calibration sections S₁ decrease progressively. This more complex arrangement can solve difficulties caused by the use of highly viscous materials or associated with the production of very thin sheathing.

It is then possible to use the die with the smallest section for the lowest speeds and then to withdraw the die with the smallest section when the speed increases. The final calibration is then effected by a die of intermediate section. When the maximum speed is reached, all the mobile dies are neutralised upstream from the central chamber and the calibration of the sheath is effected by the outlet die 4 whose section S₁ is larger than the sections Sᵢ of all the mobile dies.

The present description relates to a device for sheathing a single cord. It should be noted, however, that the principles of the invention can just as well be applied when it is desired to coat with a viscous material an array of cords arranged side by side parallel to one another in the same plane, forming a ply so as to obtain a strip of coated cords.

To do this, it suffices to adapt the section of the cord guide, the mobile die(s) and the outlet die. Instead of a circular section appropriate for a single cord, the section of these different means is elongated in the direction of the plane of the ply perpendicular to the travel direction, and adopts an oblong shape matching the width of the ply of cords.

A further object of the invention is a process for sheathing one or more cords with a plastic or thermoplastic material, using the device described. The process consists in interposing at least one mobile die 12 of calibration section S₂ smaller than the calibration section S₁ of the outlet die 4 between the central chamber 51 and the outlet die 4 when the cord(s) move(s) at low speed, and moving the mobile die 12 upstream from the central chamber 51 when the cord(s) move(s) at high speed.

The movements of the mobile die(s) are controlled by the actuator. As explained earlier, the actuator can itself be connected to an actuation mechanism such as a pneumatic jack or a linear motor, and controlled by the automatic process control system.

It then suffices to indicate to the said system the speed thresholds beyond which it is desired to move the mobile die(s). For a given sheath thickness, the control range of the pressure at which the material enters the central chamber for a given speed and calibration section is the same as for a larger calibration section and a higher speed.

To avoid localised excess sheath thickness associated with die change, a first method consists in maintaining the pressure level that gives the desired sheath thickness at a given speed and calibration section, and effecting a rapid movement of the mobile die combined with a rapid speed increase, so as to reach the larger calibration section and higher speed which correspond, at this same pressure level, to the values appropriate for obtaining a sheath thickness very close to the thickness obtained at low speed in the previous configuration. The reverse procedure is applied for changing from the high speed to the low speed.

The incoming pressure of the material into the central chamber can also be adjusted as a function of the travel speed increase of the cord until the maximum pressure level is reached, and the position of the mobile die can then be changed, reducing the pressure to a lower level, provided that means are available for regulating the pressure which can produce rapid variations.

It should be noted, however, that the movement of the mobile die may be extremely rapid and that the dynamics of the system are related above all to the dynamics of the travel speed variation of the cord.

Thus the device and process for using the device according to the invention provide means capable of producing a sheathed cord, over a large range of speeds, while maintaining essentially constant sheath thickness. The use of this device is also particularly interesting when the device according to the invention is coupled with industrial processes located downstream, in which there are large variations of the instantaneous consumption and when it is not desired to increase the size of buffer devices positioned between the sheathing device and the downstream process.

The device and process as described above enable a cord or array of cords to be sheathed by depositing a sheath of substantially constant thickness regardless of the travel speed of the cord, while controlling the pressure of the material in the central chamber within a relatively small range.

This process is used inter alia for producing large amounts of a continuous cord sheathed with rubber, such as the cords used in the fabrication of tires for vehicles.

The same device can also be used to sheathe a cord with a sheath of variable thickness, by changing the calibration section as desired and maintaining substantially constant cord travel speed and pressure of the material in the central chamber. Since the movement of the mobile die is virtually instantaneous, this enables the production of a cord with different sheath thicknesses along given and predetermined cord lengths.

The movement of the mobile die can also be controlled in alternation so as to obtain a cord with a succession of identical segments in which the sheathing thickness varies between a first thickness and a second thickness different from the first.

This application may be particularly interesting when the cord is intended for example to be used as a carcass reinforcement cord in a tire in which it is necessary to have different sheathing thicknesses on the parts of the cord located respectively in the bottom zone and in the crown zone.

1. A cord sheathing device for one or more cords (F) with a plastic or thermoplastic material, comprising:
guiding means (2) for the cord(s) arranged at the inlet of the device and leading to a central chamber (51) connected by a duct to extrusion means that can deliver the said material under pressure in the viscous condition;
an outlet die (4) of given calibration section S₁ for the sheathed cord(s); and
at least one mobile die (12) with calibration section S₂ smaller than the calibration section S₁,
wherein each mobile die (12) is moved in the travel direction of the cord(s) F by an actuator (13, 15, 17), passing through the central chamber (51), and having a passage (14) allowing the central chamber (51) to communicate with the interior space of the mobile die (12).

2. The sheathing device according to claim 1, in which, when the device is in operation, the actuator (13, 17, 14) moves the said mobile die between a position in which the said mobile die is interposed downstream from the central chamber (51) between the central chamber (51) and the outlet die (4) allowing the complete flow of material coming from the central chamber (51) to flow through the mobile die (12) after entering the passage (14) of the actuator, and a second position in which the said mobile die (12) is arranged upstream from the said central chamber (51) between the said chamber and the guiding means (2) allowing the complete flow of material coming from the central chamber (51) to flow through the outlet die (4).

3. The sheathing device according to claim 1, comprising a plurality of mobile dies, in which the mobile dies have calibration sections Sᵢ which decrease progressively from one to the next upstream from the outlet die (4).

4. The sheathing device according to claim 1, in which the section (S₁, S₂, Sᵢ) of the dies (1, 4) is of circular shape.

5. The sheathing device according to claim 1, in which the section (S₁, S₂) of the dies (1, 4) is of oblong shape.

6. The sheathing device according to claim 1, in which the extrusion means comprise means for regulating the pressure of the material in the central chamber (51).

7. A process for sheathing one or more cords with a plastic or thermoplastic material using a device according to claim 1,
wherein a mobile die (12) with calibration section S₂ smaller than the calibration section S₁ of the outlet die (4) is interposed between the central chamber (51) and the outlet die (4) when the cord(s) is/are moving at low speed, and the mobile die (1) is moved upstream from the central chamber (51) when the cord(s) is/are moving at high speed.

8. The sheathing process according to claim 7, in which a unitary cord is moved through the device so as to obtain a coated unitary cord.

9. The sheathing process according to claim 7, in which an array of cords arranged side by side parallel to one another in the same plane are moved through the device to obtain a strip of coated cords.

10. The sheathing process according to claim 7, in which the plastic material is rubber.

11. A tire comprising a sheathed cord obtained by means of the process according to claim 7.
